(19) United States
(12) Patent Application Publication
(10) Pub. No.: US 2003/0026257 A1
(43) Pub. Date: Feb. 6, 2003

(54) Network

(75) Inventors: Lin Xu, Lempaala (FI); Toni Paila, Degerby (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/128,519

(22) Filed: Apr. 24, 2002

(30) Foreign Application Priority Data
Apr. 30, 2001 (GB) 0110527.9

(51) Int. Cl. H04L 12/28

(52) U.S. Cl. 370/392

(57) ABSTRACT

Problems currently exist in determining which traffic policies should be applied to data packets from different origins or destinations in networks. Since there can be different traffic classification policy for different users, a network boundary node needs to find out which classification policy is to be applied to each data packet. Currently this is achieved through large look-up tables which must contain details of all users. The present invention aims to overcome these problems.

The present invention relates to communications over networks, and particularly to ways in which data transmitted over such networks is treated.

In packet-switched networks, such as the Internet, there typically exist two different types of data transmission: real-time and non real-time transmission. The early days of the Internet were dominated by non real-time communication, for example electronic mail (e-mail), file transfer (FTP), and Web browsing. In all of these examples, the transmission of data is insensitive to high and varying transmission delays and packet loss in the Internet. Packet loss is generally compensated by the transport control protocol (TCP) retransmission scheme. Varying and high packet delays may result in higher overall transmission times which may be still acceptable for the user. For example, the who is downloading a file will not generally notice if the download takes a few additional seconds to complete.

In contrast to this real-time transmission, such as of real-time streaming of multimedia content (e.g., video, audio) requires a continuous flow of data. Lost packets cannot be recovered by data retransmission due to the strict time guarantees that must to be met. An example of such real-time data is that used in Internet protocol (IP) telephony. In such a system, a predefined maximum end-to-end delay must not be exceeded. If a data packet requires retransmission and subsequently arrives beyond the maximum permissible delay the packet is considered to be out of date and is discarded.

As a consequence, a communication network has to provide certain Quality of Service (QoS) guarantees in order to support real time services. In network terms, QoS guarantees can be defined based on parameters such as bandwidth, packet loss, end-to-end delay, and jitter.

Differentiated Service (DiffServ) networks exist which enable packet traffic having different needs to receive different treatment, for example, according to different subscription charging policies. Thus, a subscriber A who pays a higher subscription charge than subscriber B can expect their data to experience better treatment than the data of subscriber B. When data arrives at the boundary node of a DiffServ based network, packets are classified based on header information, for example destination address, destination port number etc. Packets are classified according to a predetermined classification policy. The classification policy is applied by marking data packets with a Differentiated Service Code Point (DSCP). The DSCP is used by the interior nodes of a DiffServ network to effect different per-hop behaviour depending on the DSCP. For example, when the network is congested, packets marked with DSCP 1E will be dropped prior to packets marked with DSCP 1D.

However, problems exist in determining which traffic policies should be applied to data packets from different origins or destinations. Since there can be different traffic classification policy for different users, a boundary node needs to find out which classification policy is to be applied to each data packet.

One solution is to use a central policy server to hold the classification policies. Interrogating the central policy server to determine the classification policy to be applied to each data packet introduces delays in the packet handling process. Even if such a policy inquiry is performed for each user the processing delay and load caused by the inquiry process at the boundary node is significant in a large network. Central policy servers generally use look-up tables which map, for example, individual IP addresses to their corresponding traffic classification policies. In large systems the number of individual users can be huge, and the resulting look-up tables are slow to search through each time a traffic classification has to be applied to a data packet.

Accordingly, one aim of the present invention is to provide improvements to the way in which classification policies are determined.

According to a first aspect of the present invention, there is provided: a method of determining a service level identification to data transmitted between a device and a network, wherein the device has an address and further wherein the data is accompanied by the address, the method comprising: incorporating a first identifier in the address of the source device; analysing the data at the network boundary to identify the first identifier; determining the service level identification based on the identified first identifier.

According to a second aspect of the present invention, there is provided: apparatus for allocating the address of a device, wherein the device is intended for use with a telecommunications network, the apparatus comprising: processing means for allocating an address to the device; means for incorporating a first identifier into the address to thereby enable the network to a service level associated with the identifier.

According to a third aspect of the present invention, there is provided apparatus for determining a service level identification to data transmitted between a device and a network, wherein the device has an address and further wherein the data is accompanied by the address, comprising: an analyser for analysing the data to identify the first identifier; a processor for determining the service level identification based on the identified first identifier.

Advantageously, the present invention provides a simple policy provision scheme for allowing, for example, an efficient way of classifying IP packets at the boundary node of a DiffServ based network. Further advantageously the present invention removes the need to store a large look-up table of all user IP addresses and corresponding user classification policies in order to implement such a classification scheme. The present invention therefore removes the scalability problems that can occur, especially with mobile networks and mobile users. The present invention also provides for special cases which deviate from the normal classification policies.

The invention will now be described, by way of example only, with reference to the accompanying diagrams, in which:

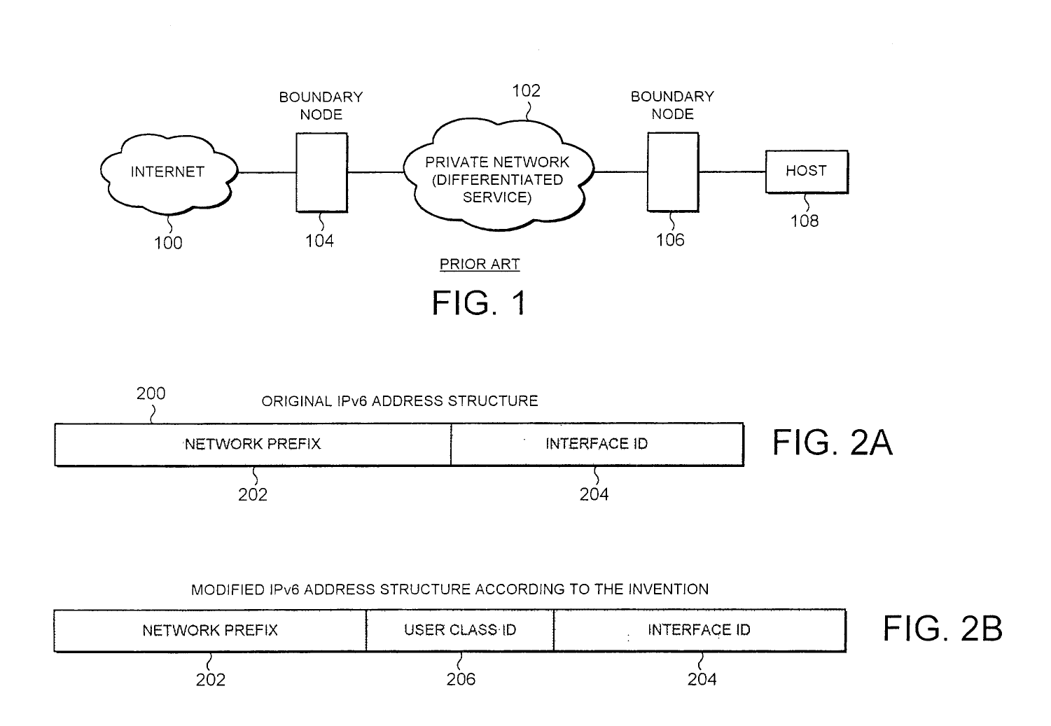

FIG. 1 is a block diagram of a system according to the prior art;

FIG. 2a shows the outline of a typical Internet protocol V6 (IPv6) address structure 200;

FIG. 2b shows the outline an Internet protocol V6 (IPv6) address according to the present invention.

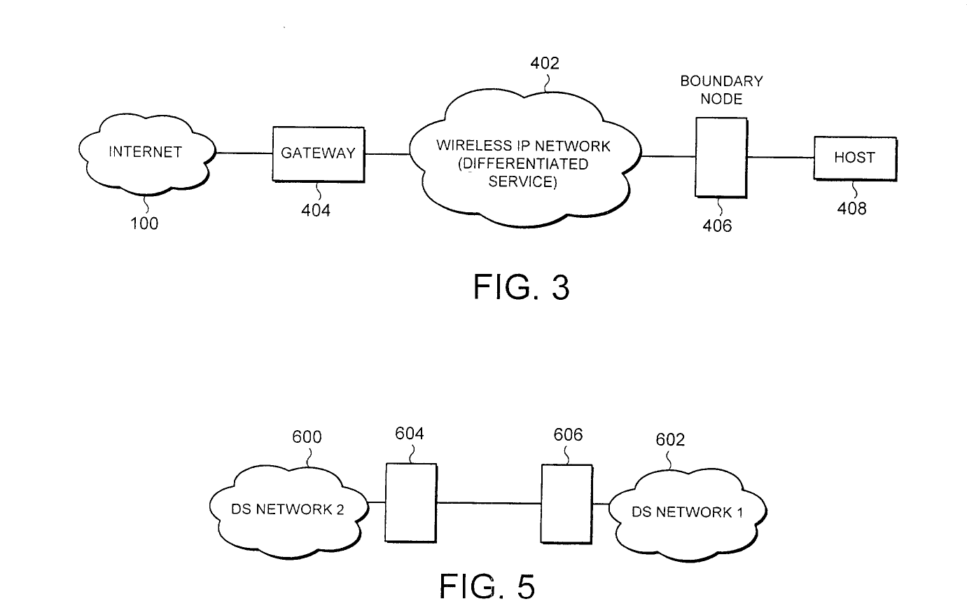

FIG. 3 is a block diagram showing a system according to one embodiment of the present invention;

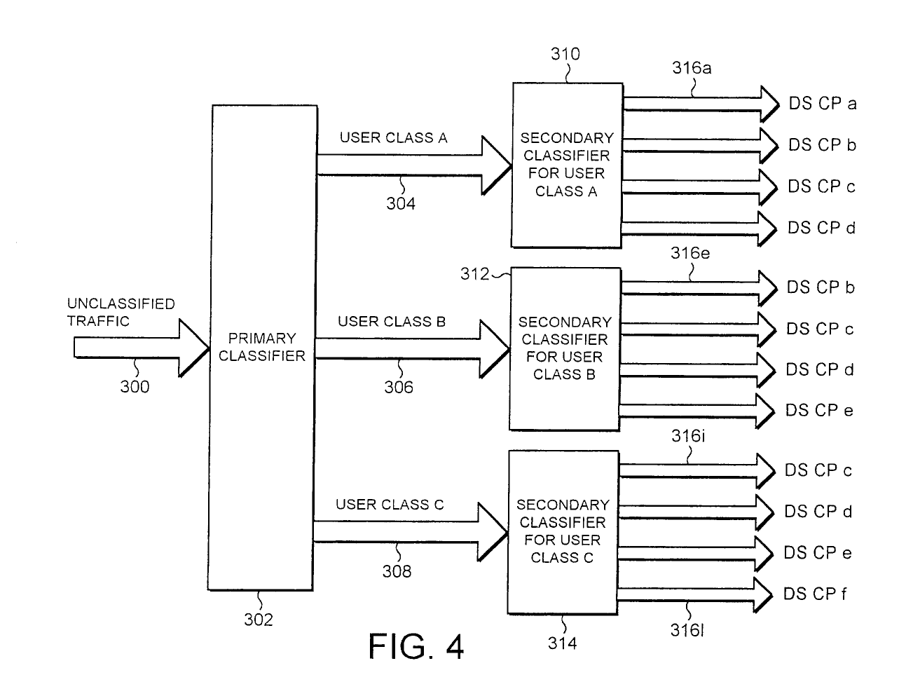

FIG. 4 is a block diagram showing the boundary node 406 of FIG. 3;

FIG. 5 shows two adjacent Differentiated Service networks 600 and 602 which communicate via boundary nodes according to the present invention;

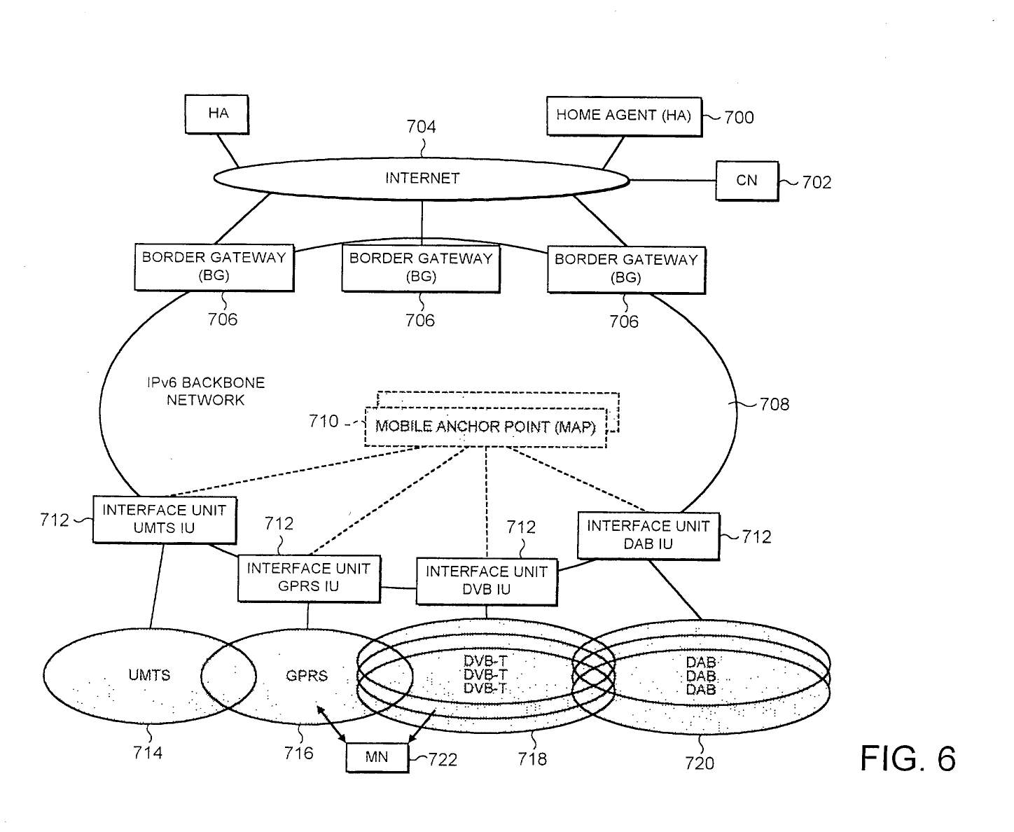

FIG. 6 is a block diagram showing an overview of a system incorporating the present invention;

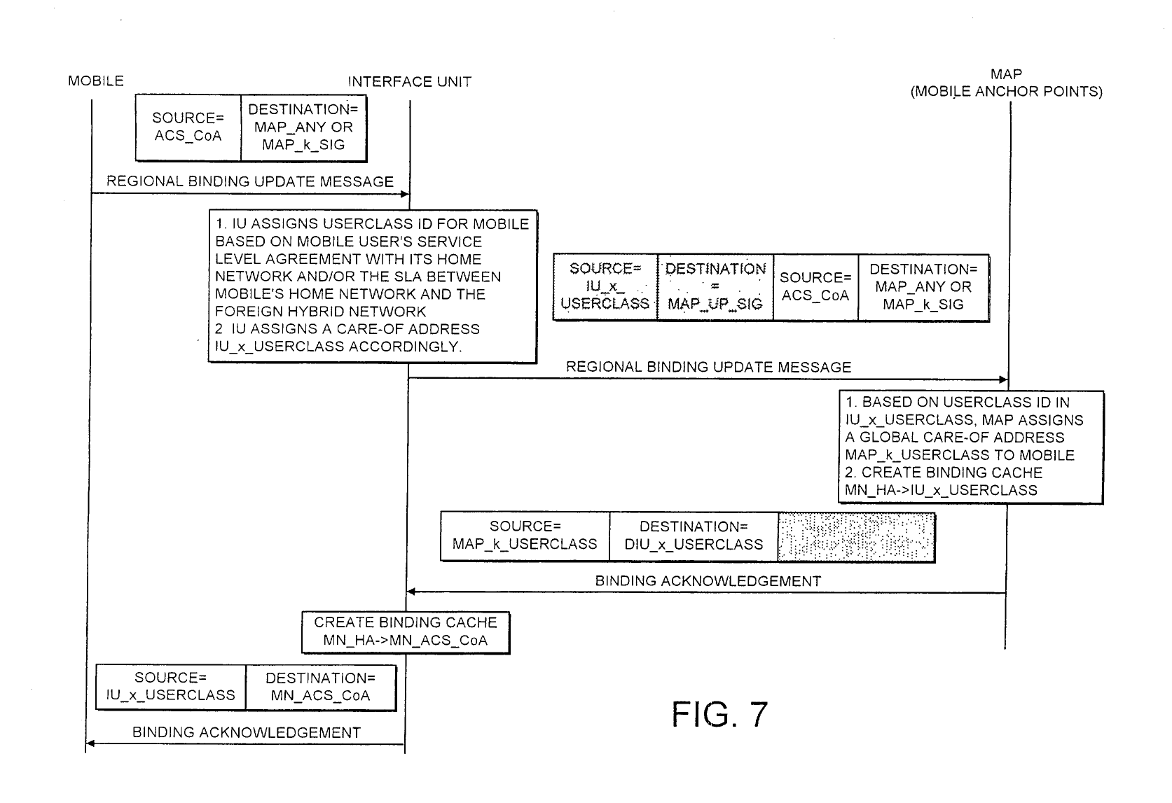

FIG. 7 is a process diagram outlining the main processes involved in allocating a care-of-address; and

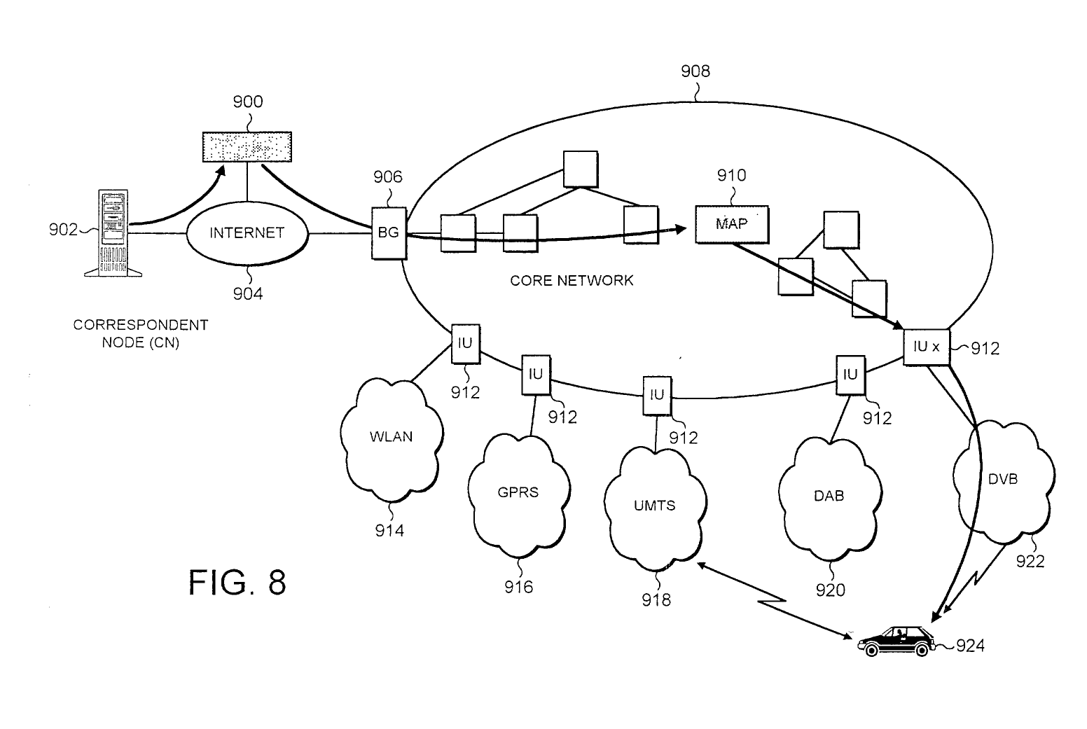

FIG. 8 is a block diagram showing an overview of yet another system incorporating the present invention.

FIG. 1 is a block diagram of a system according to the prior art. A network, such as the Internet or other internet protocol (IP) based network, 100 is connected to a private IP-based network 102 via a boundary node 104. The network 102 supports a differentiated service (DiffServ) based QoS scheme. Data packets entering the private network are classified at the boundary node 104 according to some classification criteria which could be based on, for example source address, destination address, TCP/IP port number etc. The boundary node marks each packet with a code, known as a DiffServ Code Point (DSCP), according to the classification assigned by the boundary node. The interior nodes of the network 102 (not shown) offer different Per-Hop behaviour (PHB) to packets according to the DSCP assigned to each packet. As previously mentioned, the boundary node 104 applies different traffic classification policies to different users. The boundary node achieves this by maintaining large look-up tables identifying users and their associated classification policies. This enables different DSCP codes to be applied to each data packet according to the appropriate classification policy. However, retrieving the correct classification policy for each user as each data packet arrives at a boundary node can severely degrade the performance of a boundary node.

This is especially problematic in mobile environments where there can be a great number of ‘foreign’ users entering the network. This can produce huge scalability problems, since the look-up tables need to keep a record of all users and details of the classification policy for each and every user. Additionally, these tables need to be updated regularly since in mobile environments users typically move in and out of such networks frequently.

FIG. 2 shows the outline of a typical internet protocol Version 6 (IPv6) address structure 200. The address is made up of a network prefix 202 and an interface identifier 204. Typically the interface identifier 204 is the media access control (MAC) address of the interface. The MAC address is a unique hardware identification number which uniquely identifies a specific piece of electronic hardware.

According to the present invention, the address structure is modified to include an additional user class ID 206, as shown in FIG. 2b. The user class identifier 206 is a bit field which identifies a particular user group. Each user group corresponds to a specified classification policy.

The modified IP address 202 can be allocated to a user when the user initially subscribes to a network allowing a user class identifier corresponding to the service level agreement charge to be allocated upon subscription.

By including a class identifier 206 in the address structure enables boundary nodes to easily classify data, based on a small set of traffic classification policies defined for each user class, rather than a potentially huge set of traffic classification policies defined for each user. This eliminates the need to store and maintain large look-up tables of each IP address and their corresponding traffic classification policy.

The tables below give examples of different policies to be applied to user with different service level agreements.

| | | |
|---|---|---|
| SERVICE | TRAFFIC CLASS | POLICY TO BE APPLIED |

Policy Table - USER CLASS A

| | | |
|---|---|---|
| Video Conference | Class 1 | PHB:AF11 |
| Video streaming | Class 7 | PHB:AF31 |

Policy Table - USER CLASS B

| | | |
|---|---|---|
| Video Conference | Class 4 | PHB:AF21 |
| Video streaming | Class 10 | PHB:AF41 |

Users of a network can be categorised into different users classes based on, for example, the service level agreement they have with the service providers. Typically the service level agreement will vary depending on the cost of the agreement. For example, users of class A will pay higher charges to the service providers compared to users of class B. As a result, the data traffic of class A users will be treated more favourably than the data traffic of class B users. For example, for the same type of service (e.g. video streaming), the quality of service (QoS) parameters granted to class A users will be better than those granted to class B users.

Data traffic can also be categorised into different traffic classes according to other criteria, such as transmission control protocol/user datagram protocol (TCP/UDP) port number. Data belonging to different traffic classes is associated with different quality of service (QoS) parameters, and may be treated differently in terms of bandwidth, priority, delays etc. The traffic classes are comparable to the per-hop behaviour (PHB) classes in a differentiated service (DiffServ) network.

FIG. 3 is a block diagram showing a system according to one embodiment of the present invention. A network, such as the Internet or other internet protocol (IP) based network, 100 is connected to a private IP-based network 402 via a boundary node 404. The network 402 is a so-called differentiated service (DiffServ) network. Data packets entering the private network via the boundary node are classified into different groups as based on the user class ID 206, as described below. The boundary node marks each packet with a DSCP code according to the classification policy applied by the boundary node. The interior nodes of the network 402 (not shown) may offer different Per-Hop behaviour (PHB) to packets according to the DSCP assigned to each packet. Additionally, a mobile host 408 may also connect to the network 402 via a second boundary node 406.

FIG. 4 is a block diagram showing the boundary node 406 of FIG. 3. Unclassified data traffic 300 arrives at a primary classifier 302. The primary classifier 302 identifies the user class identifier and classifies the unclassified data traffic into different user classes and produces separate data streams 304, 306 and 308 for each user class.

Each data stream 304, 306 and 308 is then input to respective secondary classifiers 310, 312 and 314. The secondary classifiers further classify the data traffic into different traffic classes and produce separate data steams 316a to 316I. The data traffic for each stream is marked accordingly by the respective secondary classifier with a predetermined DSCP code. The classification of the traffic classes in the secondary classifier can be based on various criteria, including, but not limited to, TCP/UPD port number and a fixed policy dependent on the user class.

Since each user class has its own traffic classification policy a different DSCP can be assigned for data packets belonging to the same or similar kinds of applications. For example, the video stream traffic of user group A may be marked with DSCP A, whereas the video stream traffic of user group B may be marked with DSCP B.

The actual number of data streams produced by the classifiers may vary depending on the number of different PHBs offered by the DiffServ network. The data traffic for each stream is marked accordingly, by the secondary classifier, with a predetermined DSCP code. The classification of the traffic classes can be based on various criteria, including, but not limited to, TCP/UPD port number and a fixed policy dependent on the user class.

If the mobile host 408 subscribes to the network 402 then its IP address will already contain the relevant user class identifier. However, if the mobile host is foreign to the network 402, for example it has a roaming agreement, its IP address may not contain a user class identifier. Even if the mobile host 's 408 home network allocates a user class identifier, the network 402 may apply a different user class identifier to that of the home network. To overcome this problem, when a foreign mobile host connects to the network 402, the network determines whether the home network of the foreign mobile host has a valid roaming agreement and whether the user is a valid user. If it does, and the foreign mobile host is authorised to connect to the network 402, the network 402 allocates a ‘care-of address’. A care-of address is a temporarily allocated IP address which effectively encapsulates the usual IP address of the foreign mobile host. Data sent to the original IP address will therefore arrive at the care-of address allocated. Since the care-of address is allocated by the network 402, the network also assigns a suitable user class identifier based on, for example, the service level agreement between the network 402 and the home network and the service level agreement between mobile user and its home network.

Once the care-of address has been allocated, the mobile host can communicate with nodes in network 402 or 100 via the boundary node 406 and the data traffic will be treated in the same manner as if the mobile host was in its home network.

When the mobile host 408 sends data to the network 402, the primary classifier in the boundary node 406 identifies the user class based on the IP address (i.e. the source address) of the mobile host 408. The secondary classifier in the boundary node 406 marks each packet of data with a DSCP according to the traffic classification policy.

When the mobile host 408 receives data from the internet 100, the primary classifier in the gateway 404 identifies the user class based on the destination IP address of the data (i.e. the address of the mobile host 408). The secondary classifier in the gateway 404 marks each packet of data with a DSCP according to the traffic classification policy.

In certain circumstances a user with previously allocated IP address may wish to change the traffic policy which is applied to its data, but without wishing to change the allocated IP address. Also, a user may want to have a set of special traffic classification policies. In a further embodiment of the present invention, the boundary nodes maintain a special policy look-up table of a limited number of users who fall into this category. The look-up table allows the specific traffic classification policy to be applied to the data even though the policy associated with the user class identifier indicated by the IP address is different to the actual traffic class policy which is to be applied.

In yet a further embodiment of the present invention, a further mapping table is applied to data which is transmitted from one differentiate service network to another, as exemplified in FIG. 5.

FIG. 5 shows two Differentiated Service networks 602 that have a Service Level Agreement. The boundary nodes between these two networks are 606 and 604. If the two networks do not have a common classification policy, data sent from the network may be subject to a different classification policy than intended.

Below is shown an example of a mapping table which can be simply implemented in a boundary to enable communication between two differentiated service networks.

| Network of the sender (or | User Class of the | User Class to be |
|---|---|---|
| receiver) | sender (or receiver) | applied in this domain |
| 64FF:3563:4333:7500::/60 | Class A | Class A |
| | Class B | Class B |
| | Class C | Class D |
| | Class D | Class D |
| 6532:3563:5223:7500::/60 | Class A | Class B |
| | Class B | Class C |
| | Class C | Class D |
| | Class D | Class D |

The table basically comprises the equivalent user classes in each of the two, networks. This information can be established easily by each network. The network address in the first column of the table corresponds to the network prefix 202 of FIG. 2. The primary classifier of a boundary node receiving data from another network can apply the user class conversion to ensure that data is treated, as far as possible, as originally intended.

FIG. 6 is a block diagram showing an overview of a system incorporating the present invention. A mobile node 722 can connect to any of several available networks 714, 716, 718 and 720 depending on the type of content to be delivered to the mobile node. For example, the mobile node 722 may connect to the GPRS network 716 for receiving email and browsing the Internet, although may connect to the DVB-T network 718 in order to receive video clips using the higher bandwidth provided by the DVB-T network. Each of the networks 714, 716, 718 and 720 connect to an IPv6 backbone network 708. The connection to the backbone network 708 is made via individual interface units (IU) 712. Data intended for the mobile node 722 is typically directed initially to the home agent 700. The home agent encapsulates the original packets in an IP header using the care-of address of the mobile node 722 as the destination address. Packets are then forwarded to are then forwarded to the network 708 via a border gateway 706. Since IPv6 uses a Hierarchical Mobile IP scheme the end point of the tunnel is not the mobile node 722, but is the mobile anchor 710. If route optimisation is used, it may not be necessary to use to the home agent. A correspondent node 702 can send packets directly to the mobile anchor point 701 by using a routing header. The mobile anchor point tunnels the traffic to the interface units 712 of the most appropriate network 714, 716, 718 or 720. The interface units tunnel the data to the mobile node 722 by using the care-of address assigned by each network 714, 716, 718 or 720 appropriately.

Each of the networks has to know what traffic policy to apply to data packets entering therein, as described above. The border gateways 706 therefore act in a similar way to boundary node 404 of FIG. 3. Likewise, the interface units 712 also behave in a similar way to boundary 406 of FIG. 3, with the policy decision being based on the user ID class contained within the address structure, and not based on a huge look-up table. FIG. 7 is a process diagram outlining the main processes involved in allocating a care-of-address which will be apparent to those skilled in the art.

FIG. 8 is a block diagram showing an overview of yet another system incorporating the present invention.

The present invention therefore provides a simple but highly effective way in which data from different users can be classified according to different classification policies.

Although the present invention has been described with reference to IPv6, those skilled in the art will appreciate that the same techniques can be applied to other communication protocols, including, but not limited to, IPv4.

1. A method of determining a service level identification to data transmitted between a device and a network, wherein the device has an address and further wherein the data is accompanied by the address, the method comprising:
incorporating a first identifier in the address of the source device;
analysing the data at the network boundary to identify the first identifier;
determining the service level identification based on the identified first identifier.

2. The method of claim 1, wherein the step of determining the service level identification further comprises determining the service level identification based in part on the identified first identifier, and in part on a predetermined classification policy.

3. The method of 1 or 2, wherein the step of determining the service level identification further comprises determining the service level identification based additionally on the type of data.

4. The method of claim 1, 2, 3 or 4, further comprising applying the determined service level identification to the data, to thereby enable the network to apply a corresponding predetermined quality of service.

5. The method of claim 4, wherein the step of applying the determined service level identification is adapted for applying the determined service level identification for use in a differentiated services (DiffServ) network.

6. The method of any preceding claim, further comprising storing a list of addresses in which the first identifier does not represent the desired service level.

7. The method of claim 6, further comprising storing in the list a first identifier associated with each stored address.

8. The method of claim 6 or 7, further comprising determining whether an address accompanying data is stored in the list, and determining the service level identification to be applied to the data based in part on the stored first identifier.

9. A method according to any preceding claim wherein the service level identification is a differentiated service code point (DSCP).

10. A method according to any preceding claim, wherein the class identifier is incorporated into the address when the device is first allocated a network address.

11. A method according to any preceding claim, wherein, when the device is connected to a network other than its home network, allocating the device a care-of address incorporating a first identifier.

12. A method according to any preceding claim, wherein the first identifier is a user class identifier.

13. Apparatus for allocating the address of a device, wherein the device is intended for use with a telecommunications network, the apparatus comprising:
processing means for allocating an address to the device;
means for incorporating a first identifier into the address to thereby enable the network to a service level associated with the identifier.

14. Apparatus for determining a service level identification to data transmitted between a device and a network, wherein the device has an address and further wherein the data is accompanied by the address, comprising:
an analyser for analysing the data to identify the first identifier;
a processor for determining the service level identification based on the identified first identifier.

15. The apparatus of claim 14, adapted for determining the service level identification based in part on the identified first identifier, and in part on a predetermined classification policy.

16. The apparatus of claim 14 or 15, further adapted for determining the service level identification based additionally on the type of data.

17. The apparatus of claim 14, 15 or 16, further comprising allocation means for applying the determined service level identification to the data, to thereby enable the network to apply a corresponding predetermined quality of service.

18. The apparatus of claim 17, wherein the allocation means is adapted for applying the determined service level identification for use in a differentiated services (Diff Serv) network.

19. The apparatus of any of claims 14 to 18, further comprising storage means for storing a list of addresses in which the first identifier does not represent the desired service level.

20. The apparatus of claim 19, wherein the storage means is adapted for storing in the list a first identifier associated with each stored address.

21. The apparatus of claim 19 or 20, further comprising determining means for determining whether an address accompanying data is stored in the list, and determining the service level identification to be applied to the data based in part on the stored first identifier.

22. The apparatus of any of claims 14 to 21, wherein the service level identification is a differentiated service code point (DSCP).

23. The apparatus of any of claims 14 to 22, wherein the first identifier is a user class identifier.

24. A method of applying a service level identification substantially as hereinbefore described with reference to the accompanying drawings.

25. Apparatus for applying a service level identification substantially as hereinbefore described with reference to the accompanying drawings.

26. A system for applying a service level identification substantially as hereinbefore described with reference to the accompanying drawings.
